(19) United States
(12) Patent Application Publication
(10) Pub. No.: US 2012/0223007 A1
(43) Pub. Date: Sep. 6, 2012

(54) TUBULAR MOLDED BODY CAPABLE OF FULL-WRAPPING MEMBRANE MODULE AND INDUSTRIAL FILTER ASSEMBLY USING THE SAME

(75) Inventors: Jae Hoon Moon, Daegu (KR); Sung Kyu Kim, Daegu (KR); Ki Sup Park, Gyeongsangbuk-do (KR); Sang Heum Ryu, Gyeongsangbuk-do (KR)

(73) Assignee: WOONGJIN CHEMICAL CO., LTD., Gyeongsangbuk-do (KR)

(21) Appl. No.: 13/230,349

(22) Filed: Sep. 12, 2011

(30) Foreign Application Priority Data
Mar. 3, 2011 (KR) 10-2011-18870
Mar. 3, 2011 (KR) 10-2011-18871

(51) Int. Cl. B01D 27/06; B32B 1/08; B65H 81/00

(52) U.S. Cl. 210/493.4; 156/190; 428/34.1; 428/36.9

(57) ABSTRACT

The present invention relates to a tubular molded body capable of full-wrapping a membrane module, and an industrial filter assembly using the same.

The tubular molded body of the present invention is a molded body consisting of a transparent plastic material and having a constant outer diameter that protects the membrane module through a simple manipulation using a physical fastening means to minimize the space for water stagnation, and prevents the accumulation of Mg²⁺ and Ca²⁺ to avoid a rise of the differential pressure caused by contaminants. Furthermore, the present invention provides an industrial filter assembly including a tubular molded body encasing from one end to the other of the membrane module, an industrial facility vessel protecting the exterior of the tubular molded body.

### CROSS-REFERENCE TO RELATED APPLICATION DATA

This application claims the benefit of priority of Korean Patent Application No. 10-2011-18870 filed Mar. 3, 2011 and Korean Patent Application No. 10-2011-18871 filed Mar. 3, 2011 entitled, “TUBULAR MOLDED BODY CAPABLE OF FULL-WRAPPING MEMBRANE MODULE AND INDUSTRIAL FILTER ASSEMBLY USING THE SAME.”

### BACKGROUND OF THE INVENTION

1. Field of the Invention

The present invention relates to a tubular molded body capable of full-wrapping a membrane module and an industrial filter assembly using the same and, more particularly, to a tubular molded body and an industrial filter assembly using the same, in which the tubular molded body consisting of a transparent plastic material can be used through a simple manipulation with a physical fastening means as a substitute for a conventional wrapping processing using a wrapping solution, to protect the membrane module simply by assembling without using a separate facility necessary for the wrapping process, thereby reducing the time and cost for the wrapping process, minimizing stagnation of feed water with the product mounted, solving the problem regarding stagnation of water with the holes formed in the tubular molded body, and improving the differential pressure.

2. Background Art

The membrane module fabrication process is largely comprised of five processes. The first process, a primary coating process, involves applying a polymer solution on a nonwoven fabric to enhance the physical properties of the reverse osmosis membrane and form a porous structure of the support layer through a phase separation.

The second process, a secondary coating process, forms a polyamide coating layer on the top of the first-coated support layer through an interfacial polymerization between amine and acid. The polyamide coating layer implements the final salt removing function.

The third process involves winding a membrane, a tricot and a mesh into a spiral module and wrapping the module. Here, wrapping is necessary for protecting the membrane against shock during a handling of the module and preventing telescoping occurring in high-pressure operation. The wrapping process also prevents potential damages of the module caused by the occurrence of a differential pressure.

The fourth process is determining acceptability of the processed module in regard to the properties. Acceptability is based on flux, the quantity of water passing through the membrane per unit time; salt rejection, the quantity of impurities removed from the feed water through the membrane; and TOC rejection, the quantity of total organic carbon (TOC) removed from the feed water.

Finally, the fifth process is an after-treatment process performing sterilization and chemical conditioning to prevent proliferation of microorganisms and viruses potentially occurring during product distribution. After completion of all the processes, the accepted products are subjected to the final inspection, wrapping and then shipment.

Hereinafter, a description will be made in regard to the subject of the present invention, the wrapping process subsequent to the winding process in the fabrication of a membrane module. FIG. 1 is a stepwise illustration of a wrapping process in the membrane module fabrication process that includes: winding a membrane, a tricot, and a mesh in sequential order outwardly form the core into a spiral membrane module having a polyamide layer on a support layer; trimming the membrane module; attaching end caps on both ends of the membrane module; and carrying out a wrapping process on the membrane module with the end caps fastened together.

The wrapping process is carried out under high pressure condition, reinforcing the exterior of the module with a fiber reinforced plastic (FRP) containing glass fiber and epoxy resin in order to make the product tolerate a high pressure condition.

FIG. 2 is a detailed stepwise illustration of the wrapping process in the fabrication of a membrane. First, an epoxy resin and a curing agent are mixed at an appropriate ratio to prepare a wrapping solution, and glass fiber is impregnated with the wrapping solution containing the epoxy resin. The glass fiber coated with the epoxy resin is then applied to wrap the exterior of the rotating membrane module. The residual epoxy resin is evenly spread with a silicon pad. The wrapped module is transferred to a curing room and subjected to curing.

However, the wrapping process causes the difficulty in changing labels on the wrapped products and requires a separate wrapping facility and a special curing room. The wrapping process also has a problem in difficulty of cleaning the wrapping facility, requires a work of trimming the exterior of the product, and with a need for end caps mounted on the module.

In this conventional wrapping process, the use of the wrapping solution containing an epoxy resin results in a long curing time of about 6 to 12 hours due to the wetness of the epoxy resin, consequently with difficult handling. As the degree of cure and the curing time are dependent upon the mixing ratio of the epoxy resin and the curing agent in the wrapping solution, the wrapping process has problems in that the mixing ratio is hard to regulate and that an inappropriate mixing ratio of the wrapping solution ends up with a waste of the solution, causing an additional cost for disposal of the waste solution. For example, production of the waste solution brings about a need for a separate storage for the waste solution and an additional cost for waste disposal, and with a difficulty of handling the waste solution due to the heat generated while the waste solution is cured.

The cured epoxy resin is difficult to remove, necessarily needing a manual work to raise the cost and cause a difference in quantity of the waste solution removed among the workers. Even a low quantity of residual epoxy resin causes a dislocation of the glass fiber. In addition, the membrane module, when wrapped with glass fiber coated with the epoxy resin in the conventional wrapping process encounters water stagnation and inevitably water contamination.

In an attempt to solve these problems, there has been a try to use a full-fit polypropylene mesh as an alternative wrapping material. This may prevent water stagnation in the membrane, but with a low recovery rate.

To solve the problems with the wrapping process in the conventional membrane module fabrication process, the inventors of the present invention have accomplished that there is provided a plastic molded body capable of full-wrapping a membrane module. The plastic molded body of the present invention can encase the membrane module obtained after the winding process through a physical fastening means and forming holes in the molded body to prevent water stagnation. Therefore, the plastic molded body of the present invention substitutes for the conventional wrapping process using glass fiber coated with an epoxy resin.

### SUMMARY OF THE INVENTION

Accordingly, it is an object of the present invention to provide a tubular molded body capable of full-wrapping a membrane module.

It is another object of the present invention to provide an industrial filter assembly equipped with a tubular molded body capable of full-wrapping a membrane module to facilitate fastening and assembling of the product and to eliminate the problem of water stagnation in the membrane.

To accomplish the above objects of the present invention, there is provided a tubular molded body designed to wrap from one end to the other of a spiral membrane module prepared by winding a membrane, a tricot, and a mesh in sequential order outwardly from a core.

The tubular molded body of the present invention uses at least one transparent plastic material selected from the group consisting of a polypropylene resin, an acrylonitrile-butadiene-styrene copolymer resin, an acryl-based resin, a polymethacrylate (PMMA) resin, a polycarbonate (PC) resin and a cyclo-olefin copolymer/polymer resin.

Preferably, the tubular molded body of the present invention encases the whole membrane module and has an outer diameter that allows a gap of at most 2 mm between the encased membrane module and the tubular molded body. The tubular molded body has holes arranged to form a flow passage.

More preferably, the tubular molded body consisting of a plastic material includes a pair of semi-cylindrical tubes integrally formed with end caps and designed to wrap from one end to the other of the membrane module. The semi-cylindrical tubes are fastened up and down together through hook fastening means and then are melt and more fastened by heat or ultrasound bonding.

The tubular molded body consisting of a plastic material according to the present invention includes a cylindrical tube designed to wrap from one end to the other of a membrane module. The cylindrical tubes are coupled to each other with end caps fastened together through a hook or screw type fastening means and then are melt and more fastened by heat or ultrasonic bonding.

The tubular molded body consisting of a plastic material according to the present invention may encase two or more membrane modules arranged in serial without a gap between them.

The present invention also provides an industrial filter assembly that includes: a spiral membrane module prepared by winding a membrane, a tricot, and a mesh in sequential order outwardly from the core; a tubular molded body encasing the whole membrane module; and a facility vessel for protecting an exterior of the tubular molded body.

The industrial filter assembly has a gap of 2 mm or less between the membrane module and the tubular molded body, and a gap of 2 mm or less between the tubular molded body and the facility vessel.

Preferably, the tubular molded body includes a pair of semi-cylindrical tubes fastened up and down together through hooks, or through end caps using hook or screw type fastening means.

The industrial filter assembly of the present invention includes a structure of encasing two or more membrane module in serial without a gap between them in the tubular molded body to minimize water leak.

The tubular molded body has holes to minimize the differential pressure between the feed water portion and the concentrated water portion of the membrane and thus is preventing contamination.

Preferably, the tubular molded body uses at least one transparent plastic material selected from the group consisting of a polypropylene resin, an acrylonitrile-butadiene-styrene copolymer resin, an acryl-based resin, a polymethacrylate resin, a polycarbonate resin and a cyclo-olefin copolymer/polymer resin. This facilitates putting labels on the exterior of the tubular molded body and thereby eliminates a need for the conventional labeling process on the membrane module.

The present invention provides a tubular molded body consisting of a transparent plastic material that is capable of wrapping from one end to the other of a membrane module. According to using the tubular molded body, it is reduced the curing time and procedure of the conventional wrapping process using the wrapping solution and is solved the problem with the cost for waste disposal after a use of the wrapping solution.

The use of the tubular molded body of the present invention makes it possible to substitute the wrapping process using a wrapping solution, protects the membrane module through a simple physical assembling, eliminates a need for separate facilities for the wrapping process, and saves the wrapping time by assembling to reduce the production cost.

The industrial filter assembly that includes the tubular molded body encasing the membrane module and a facility vessel for protecting the exterior of the tubular molded body can prevent the problem of the membrane caused by accumulation of Mg²⁺ and Ca²⁺.

### BRIEF DESCRIPTION OF THE DRAWINGS

FIG. 1 is a stepwise illustration showing a conventional wrapping process using a wrapping solution after preparing a membrane module by a winding process in a membrane module fabrication process.

FIG. 2 is a detailed stepwise illustration of the wrapping process of FIG. 1.

FIGS. 3 and 4 show a first embodiment of a tubular molded body of the present invention, which is a semi-cylindrical tubular molded body integrally formed with end caps and a hook type fastening means before assembling.

FIG. 5 shows the tubular molded body with the hook type fastening means fastened together after assembling in FIGS. 3 and 4.

FIG. 6 is an enlarged view of the tubular molded body integrated with end caps in FIG. 5.

FIG. 7 is a schematic view showing an example of a cylindrical tubular molded body as a second embodiment of a tubular molded body of the present invention.

FIG. 8 is a schematic showing another example of a cylindrical tubular molded body as the second embodiment of the tubular molded body of the present invention.

FIG. 9 is a photograph showing a comparison between the exterior (top) of a product obtained from the wrapping process of the present invention and the exterior (bottom) of a product from the conventional wrapping process.

### DETAILED DESCRIPTION OF THE PREFERRED EMBODIMENT

Hereinafter, the present invention will be described in detail.

The present invention provides a tubular molded body capable of full-wrapping a membrane module.

More specifically, the present invention provides a tubular molded body designed to wrap from one end to the other of a spiral membrane module prepared by winding a membrane, a tricot and a mesh in sequential order outwardly from the core. The preferred material of the tubular molded body is selected depending on the requirements of acid resistance, alkali resistance, or pressure resistance, and can be customized to personal specifications by alternation of the materials.

The more preferred material of the tubular molded body is a heat-resistant transparent resin or an elastic transparent resin that meet the above requirements, including, for example, at least one transparent plastic material selected from the group consisting of a polypropylene resin, an acrylonitrile-butadiene-styrene copolymer resin, an acryl-based resin, a polymethacrylate (PMMA) resin, a polycarbonate (PC) resin and a cyclo-olefin copolymer/polymer resin.

The tubular molded body capable of full-wrapping a membrane module according to the present invention can be substituted for the conventional wrapping process using a wrapping solution, and hence does not need a separate working space or facility for the wrapping process.

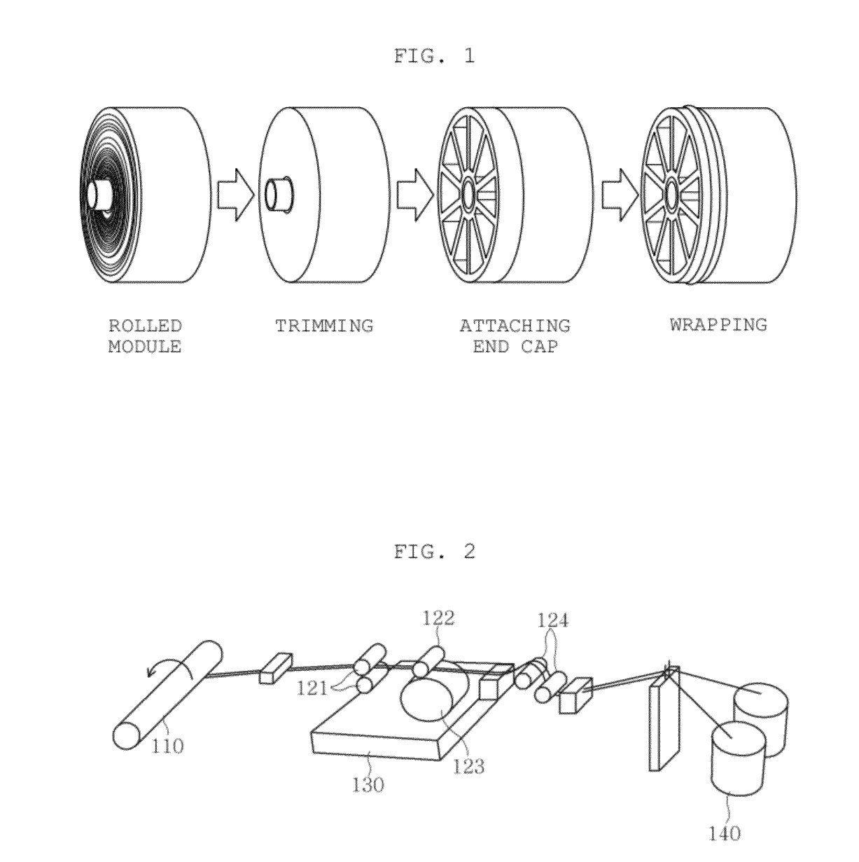

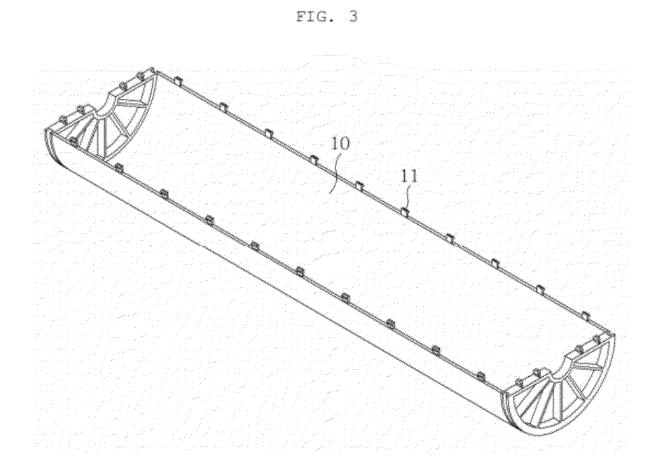

Hence, the present invention uses a tubular molded body capable of physical fastening manipulation as a wrapping process after the winding process in the fabrication of a membrane module, to omit a trimming process and an end cap mounting process necessary in the conventional wrapping process using a wrapping solution in FIG. 1. The omission of the conventional wrapping process using a wrapping solution shown in FIG. 2 solves the problem in regard to the curing time and procedures of the wrapping solution. The used tubular molded body can be taken apart for reuse in the future. This does not require an additional processing cost and thus reduces the membrane module production cost.

The tubular molded body of the present invention comprises a transparent plastic material and formed in a mold to have a constant outer diameter with excellent dimension stability. Owing to this characteristic, the tubular molded body of the present invention avoids the problems with the conventional wrapping process using a wrapping solution that causes non-uniform ingredient mixing between an epoxy resin and glass fiber in the winding process and the occurrence of the outer diameter difference according to the workers.

The membrane module wrapped by the conventional process using a wrapping solution is hourglass-shaped when the product is mounted, inevitably forming a space for water stagnation. Contrarily, the tubular molded body capable of full-wrapping a membrane module according to the present invention is formed in a mold to have a constant outer diameter that allows a straight exterior of the product, minimizing stagnation of the feed water with the product mounted.

The tubular molded body of the present invention has an outer diameter to cover the whole wound membrane module and allows a gap of 2 mm or less between the membrane module and the tubular molded body. The gap is determined in consideration of the swelling of the membrane module while water is flowing. Actually, the gap between the membrane module and the tubular molded body is to be occupied by the swollen membrane module.

If necessary, the tubular molded body of the present invention can be provided with holes on the exterior of the product to form a new flow passage, while the conventional membrane module fabrication method provides a flow passage only on the ATD side in the direction of output water and the interior of the pipe. Generally, Mg²⁺ and Ca²⁺ ions existing in the feed water are accumulated on the membrane during water purification, thereby is increasing the contamination and the differential pressure. However, the present invention that forms a flow passage through holes can enhance contamination resistance with reduced differential pressure and prevent potential damages of the module.

The shape, size and number of the holes formed on the rear side of the tubular molded body consisting of a plastic material according to the present invention are not specifically limited and may be altered by those skilled in the art as long as the purpose of forming a flow passage through holes and improving the differential pressure is achieved.

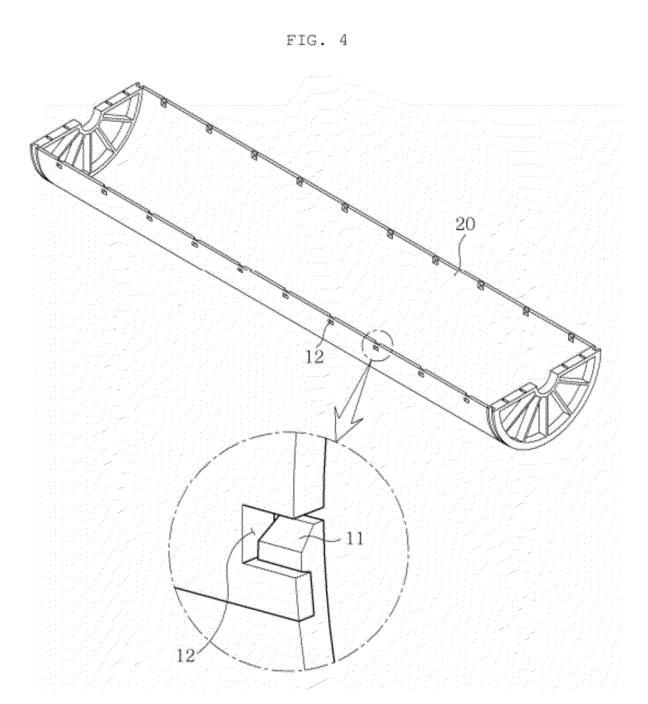

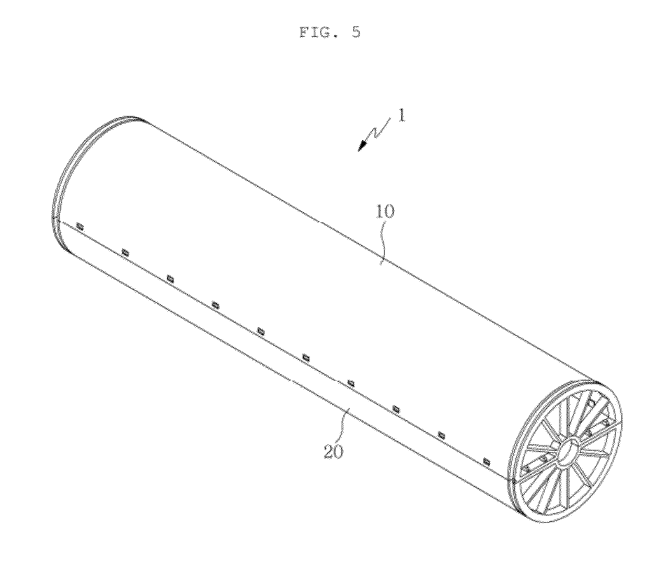

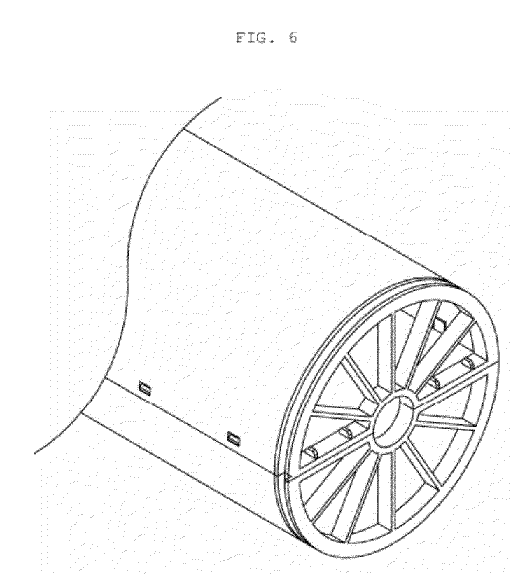

The first preferred embodiment to implement the tubular molded body capable of full-wrapping a membrane module according to the present invention is a semi-cylindrical tubular molded body integrally formed with end caps as shown in FIGS. 3 to 6.

More specifically, the present invention includes a pair of semi-cylindrical tubular molded bodies 10 and 20 integrally formed with end caps and having hooks formed as upper and lower fastening means along their edges and fastened up and down together. The semi-cylindrical tubular molded bodies 10 and 20 are arranged to face each other and fastened together. With a spiral membrane module encased in the semi-cylindrical tubular molded bodies 10 and 20, the hooks are fastened up and down together, and the membrane module is then wrapped.

The semi-cylindrical molded bodies 10 and 20 integrally formed with end caps are designed and prepared by injection module to have a gap of 1 to 2 mm from the encased membrane module. Along the edges of the semi-cylindrical tubular molded bodies integrally formed with end caps are formed a pair of hooks 11 and 12 at predetermined intervals so that the hooks 11 and 12 are fastened up and down together, with the proviso that the hooks are not protruding from the exterior of the entire tubular molded body.

More specifically, the hook fastening portion includes: hooks 11 formed along the edge of the one semi-cylindrical molded body 10 integrally formed with end caps; and grooves 12 formed along the edge of the other semi-cylindrical molded body 20 and capable of being fastened to the hooks 11 at positions corresponding to the projecting hooks 11. Preferably, the grooves 12 are formed in size equal to or smaller than the projections of the hooks 11. The hook fastening portion is not protruding from the exterior of the entire tubular molded body. Any known method may be applied as long as the hooks are fastened without protruding from the exterior of the entire tubular molded body. After fastened, the hook fastening portion is melt and more fastened under heat or ultrasonic bonding.

The semi-cylindrical molded bodies 10 and 20 integrally formed with end caps encase a bundle of at least two membrane modules arranged in series without a gap between them, securing the maximum effective area of membranes in an equivalent product size. In other words, the effective area of membranes of the actual product can be increased, since there is no need for end caps per module.

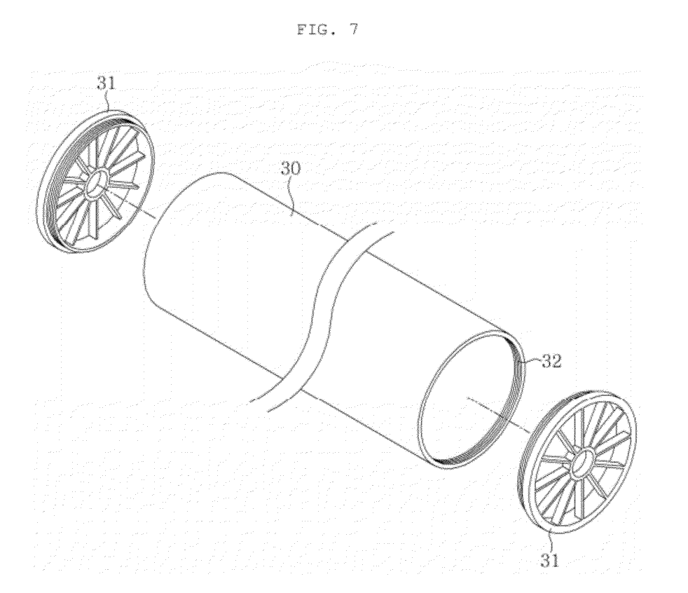

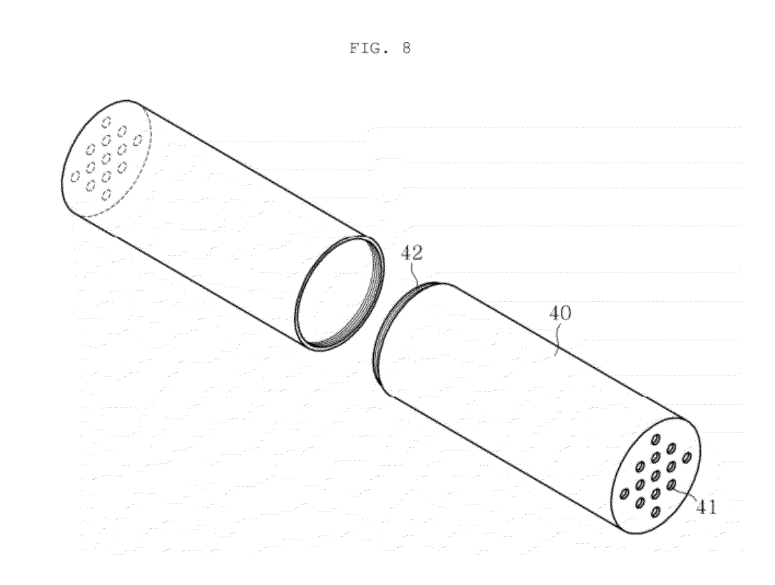

The second preferred embodiment to implement the tubular molded body capable of full-wrapping a membrane module according to the present invention is a cylindrical tubular molded body illustrated in FIGS. 7 and 8, which can be prepared by extrusion molding.

For a more specified example, as shown in FIG. 7, a cylindrical member 30 is prepared by extrusion molding, and a membrane module is encased in the molded body of the cylindrical member. End caps 31 are then fastened to both ends of the cylindrical member 30 via a hook or screw type fastening means.

For another specified example, as shown in FIG. 8, a cylindrical member 40 is prepared, with the one end integrally formed with an end cap and the other end open. A membrane module is encased in the one cylindrical member 40, which is then covered with the other cylindrical member 40. The cylindrical member 40 is fastened together via a hook or screw type fastening means.

The cylindrical tubular molded body, after fastened through a hook or screw type fastening means, can be melt and more fastened under heat or ultrasonic bonding.

The inlet/outlet means formed in the end cap are not specifically limited as long as they allow a smooth flow of water.

The present invention provides an industrial filter assembly that includes: a spiral membrane module prepared by winding a membrane, a tricot, and a mesh in sequential order outwardly from the core; a tubular molded body encasing the whole membrane module; and a facility vessel for protecting an exterior of the tubular molded body.

The industrial filter assembly of the present invention is provided with the above-described tubular molded body to reserve the improving effect pertaining to the tubular molded body.

The tubular molded body can be customized to personal specifications by alternation of the ingredients. Here, the ingredients are selected according to the desired requirements, such as acid resistance, alkali resistance, or pressure resistance, to produce a personally desired product.

Preferably, the material for the tubular molded body is a heat-resistant transparent resin or an elastic transparent resin that meets the above requirements. More specifically, the tubular molded body is prepared from at least one transparent plastic material selected from the group consisting of a polypropylene resin, an acrylonitrile-butadiene-styrene copolymer resin, an acryl-based resin, a polymethacrylate (PMMA) resin, a polycarbonate (PC) resin and a cyclo-olefin copolymer/polymer resin.

When the membrane module is wrapped by the conventional process using a wrapping solution, it is deformed to hourglass-shaped. Then the product is mounted, inevitably forming a space for water stagnation. Contrarily, the tubular molded body capable of full-wrapping a membrane module according to the present invention is formed in a mold to have a constant outer diameter that allows a straight exterior of the product, minimizing stagnation of the feed water in the membrane. Hence, the present invention does not need a U-CUP used in the prior art to solve the problem of water stagnation caused by the shape of an hourglass.

The industrial filter assembly of the present invention has a gap of 2 mm or less between the membrane module and the tubular molded body, and moreover, a gap of 2 mm or less between the tubular molded body and the facility vessel, which lets air in the gap and prevents the inlet water from flowing back out of the membrane. The use of the tubular molded body integrally formed with end caps according to the present invention minimizes the gap between the product and the mounted vessel.

The preferred structure of the tubular molded body encasing the whole membrane module in the industrial filter assembly of the present invention is a pair of semi-cylindrical tubular molded bodies fastened up and down together via a pair of hooks; or a cylindrical tubular molded body fastened together with a hook or screw type fastening means (in FIGS. 3 to 8).

The industrial filter assembly of the present invention has the tubular molded body encasing a bundle of at least two membrane modules arranged in series without a gap between them, securing the maximum effective area of membranes in an equivalent product size. In other words, the effective area of accepted membranes in the actual product can be increased because there is no need for end caps per module.

The industrial filter assembly of the present invention also has holes formed in the tubular molded body to induce a flow passage. This increases the contamination resistance of the membrane and reduces the differential pressure, consequently preventing potential damages of the membrane module. Preferably, the holes are formed on the rear side of the tubular molded body, but the positions of the holes are not specifically limited as long as the holes form a flow passage to reduce the differential pressure. The size and number of the holes are also not specifically limited and may be altered by those skilled in the art.

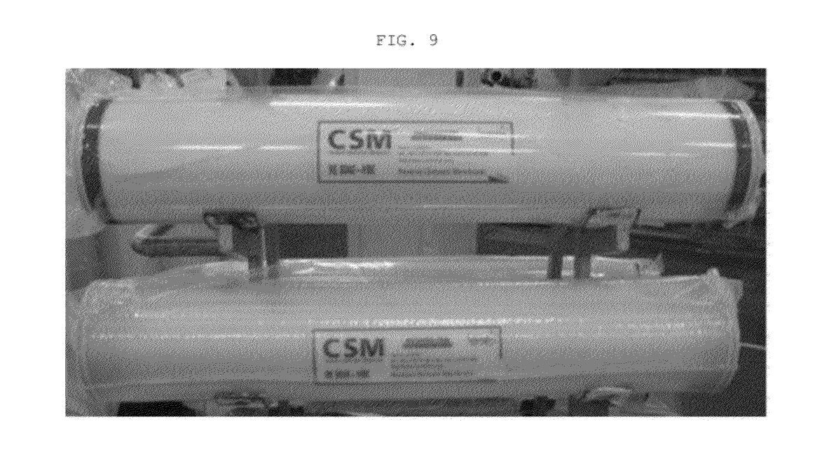

FIG. 9 is a photograph showing a comparison between the exterior (top) of a product obtained from the wrapping process of the present invention and the exterior (bottom) of a product from the conventional wrapping process. Upon occurrence of performance problems, the product prepared by the conventional method needs to be taken apart to remove the module after re-evaluation. But the product of the present invention using a tubular molded body of a high-transparency plastic material can be seen through from the outside and convenient to check out the inside without disassembled.

In addition, the industrial filter assembly of the present invention is eco-friendly in regard to disposal of the used product, because of the plastic case type structure that renders the tubular molded body detachable after a use and reusable according to a kind of the materials. Moreover, the industrial filter assembly of the present invention uses the case type structure as a means of the wrapping process and does not need a separate working space or facility for the wrapping process, thereby reducing the production time and cost.

Hereinafter, the present invention will be described in further detail with reference to the examples as follows.

The following examples are given to describe the present invention in detail based on the best modes and not intended to limit the scope of the present invention.

### Example 1

A 140 μm-thick porous polysulfone support including nonwoven fabric on the backside was immersed in an aqueous solution containing 2 wt % of m-phenylene diamine (MPD) and 0.2 wt % of 2-ethyl-1,3-hexanediol for 40 seconds and taken out to eliminate an excess of the aqueous solution. Subsequently, the coated support was immersed in a solution containing 0.1 wt % of trimesoyl chloride (TMC) dissolved in ISOPAR® solvent (Exxon Corp.) for one minute and taken out to eliminate an excess of the organic solution, to prepare a polyamide reverse osmosis composite membrane.

The polyamide reverse osmosis composite membrane, a tricot, and a mesh in sequential order were wound outwardly from the core to form a spiral membrane module.

The spiral membrane module was encased in the one of a pair of semi-cylindrical tubes integrally formed with end caps and consisting of a polypropylene resin, and covered with the other semi-cylindrical tube. The semi-cylindrical tubes were fastened together with a fastening structure of hooks 11 and 12.

The membrane module thus obtained was evaluated in regard to properties, and the accepted membranes were subjected to sterilization and chemical conditioning and wrapped up.

### Example 2

Procedures were performed in the same manner as described in Example 1, excepting that a spiral membrane module is encased in a pair of semi-cylindrical members 10 and 20 integrally formed with end caps and consisting of an acylonitrile-butadiene-styrene copolymer material.

### Example 3

Instead of the semi-cylindrical tube integrally formed with end caps, a 1m-long cylindrical member 30 consisting of a polypropylene resin was prepared by extrusion molding. In the cylindrical tubular molded body was encased a spiral membrane module, with the end caps 31 screwed on both ends of the cylindrical tubular molded body via a screw type fastening means (in FIG. 7). Here, the spiral membrane module was prepared in the same manner as described in Example 1.

### Example 4

Instead of the semi-cylindrical tube integrally formed with end caps in Example 1, a cylindrical member 40 consisting of a polypropylene resin was prepared by extrusion molding. The one end of the cylindrical tubular molded body was integrally formed with an end cap, with the other end open. The molded body was 50 cm long, with an end cap 41 having a hole profile 41. A spiral membrane module was encased in the inlet opening of the one 50 cm-long cylindrical member 40, which was fastened to the other 50 cm-long cylindrical member 40 (in FIG. 8). The two molded bodies were fastened together through a pair of screw type fastening means 42 formed on each inlet opening side. The spiral membrane module was prepared in the same manner as described in Example 1.

### Comparative Example 1

The polyamide reverse osmosis composite membrane of Example 1, a tricot, and a mesh in sequential order were rolled on the core to prepare a spiral membrane module.

An epoxy resin and a curing agent were mixed at a mixing ratio of 1.6:1 to prepare a wrapping solution, and glass fiber was impregnated with the wrapping solution. The membrane module was mounted and rotated, and glass fiber coated with the epoxy resin was then applied to wrap the exterior of the rotating membrane module. Here, the residual epoxy resin was evenly spread with a silicon pad. The wrapped module was transferred to a curing room and subjected to curing. The subsequent procedures were performed in the same manner as described in Example 1.

### Experimental Example 1

### Measurement of Differential Pressure

The membranes prepared in Example 1 and Comparative Example 1 were measured in regard to the pressure difference between the feed water portion and the concentrated water portion of the membranes, and the differential pressure (DP) was calculated according to the following equation 1.

It is on the assumption that with a recovery of 15% and a flux of 10,500 GFD for output water, the differential pressure DP is constant when there is no physical obstacle such as a supply channel or a foulant.

With a fixed flux of output water 10,500 GFD (27.6 LPM) and concentrated water 59,500 GFD (156.4 LPM) and a constant feeding speed, the measurement results of differential pressure are presented in Table 1.

Differential Pressure (DP)=α×(Q_{avg})^{β} [Equation 1]

where Q_{avg}=(Q_{f}+Q_{c})/2; Q_{f} is the pressure of the feed water; Q_{c} is the pressure of the concentrated water; α and β are experimental constants; and β=1.5˜2.0.

TABLE 1

| | | Evaluation Result | | Re-evaluation | | |
|---|---|---|---|---|---|---|
| | | | Salt | | Salt | Differ- |
| Membrane | | Flux | Rejec- | Flux | Rejec- | ential |
| Module | Wrapping | (GFD) | tion (%) | (GFD) | tion (%) | pressure |
| 8040-BE | Example 1 | 10,250 | 99.59 | 10,008 | 99.72 | 3.9 |
| | Comparative | 10,180 | 99.58 | 10,160 | 99.69 | 4.6 |
| | Example 1 | | | | | |

As seen from the results of Table 1, where the wrapping process was varied for the same membrane module, the membrane had a low differential pressure when the tubular molded body consisting of a transparent material was used to wrap the whole membrane module according to the present invention. In conclusion, the present invention minimizes the differential pressure between the feed water portion and the concentrated water portion of the membrane and prevents contamination and consequently potential damages of the membrane module.

As described above, the present invention provides a tubular molded body capable of full-wrapping a membrane module.

The tubular molded body of the present invention consisting of a transparent plastic material can be used through a simple manipulation with a physical fastening means instead of a conventional wrapping process. This reduces the curing time and the procedure of conventional wrapping process using a wrapping solution and solves the problem regarding the cost for waste disposal after uses.

The present invention also eliminates a trimming process and an end cap mounting process necessary in the conventional wrapping process using a wrapping solution, saves the curing time of the epoxy resin used in the wrapping solution to reduce the production time, facilitates the disassembling of the product due to the detachable tubular molded body to enable reuse in the future, and allows the inside check-out without disassembling due to the transparent material of the tubular molded body.

The transparent tubular molded body encases at least two membrane modules without a gap between them, eliminating a need for end caps per module to increase the effective area of membranes in an actual product, with a low possibility of water leak, and is thus suitable for industrial use purpose.

The present invention also provides an industrial filter assembly that includes a tubular molded body encasing a membrane module; and a facility vessel for protecting the exterior of the tubular molded body. The industrial filter assembly of the present invention is made in a mold to have a constant outer diameter that allows a straight exterior of the product, minimizing stagnation of the feed water when the product is installed.

The industrial filter assembly induces a flow passage through holes formed in the tubular molded body corresponding to the flow direction of the output water, to prevent the accumulation of Mg²⁺ and Ca²⁺ and avoid a rise of the differential pressure caused by the contaminants.

Furthermore, the industrial filter assembly of the present invention uses the tubular molded body to encase a bundle of at least two membrane modules arranged in series without a gap between them, securing the maximum effective area of membranes in an equivalent product size.

While the present invention has been described with reference to the particular illustrative embodiments, it is to be appreciated that those skilled in the art can change or modify the embodiments without departing from the scope and spirit of the present invention.

What is claimed is:

1. A tubular molded body capable of full-wrapping a membrane module, the tubular molded body being designed to wrap from one end to the other of a spiral membrane module prepared by winding a membrane, a tricot, and a mesh in sequential order outwardly from a core.

2. The tubular molded body as claimed in claim 1, wherein the tubular molded body comprises at least one transparent plastic material selected from the group consisting of a polypropylene resin, an acrylonitrile-butadiene-styrene copolymer resin, an acryl-based resin, a polymethacrylate resin, a polycarbonate resin and a cyclo-olefin copolymer/polymer resin.

3. The tubular molded body as claimed in claim 1, wherein the tubular molded body is designed to have a gap of 2 mm or less from the spiral membrane module.

4. The tubular molded body as claimed in claim 1, wherein the tubular molded body has holes arranged to form a flow passage.

5. The tubular molded body as claimed in claim 1, wherein the tubular molded body includes a pair of semi-cylindrical tubes integrally formed with end caps and fastened together through a hook type fastening means to wrap the whole membrane module.

6. The tubular molded body as claimed in claim 1, wherein the tubular molded body includes a cylindrical tube capable of full-wrapping the membrane module.

7. The tubular molded body as claimed in claim 6, wherein the cylindrical tube has end caps on both ends thereof, the end caps being fastened together through a hook or screw type fastening means.

8. The tubular molded body as claimed in claim 1, wherein the tubular molded body encases at least two membrane modules arranged in series.

9. An industrial filter assembly comprising:
a spiral membrane module prepared by winding a membrane, a tricot, and a mesh in sequential order outwardly from a core thereof;
a tubular molded body encasing the whole membrane module; and
a facility vessel for protecting an exterior of the tubular molded body.

10. The industrial filter assembly as claimed in claim 9, wherein the industrial filter assembly has a gap of 2 mm or less between the membrane module and the tubular molded body.

11. The industrial filter assembly as claimed in claim 9, wherein the industrial filter assembly has a gap of 2 mm or less between the tubular molded body and the facility vessel.

12. The industrial filter assembly as claimed in claim 9, wherein the tubular molded body includes a pair of semi-cylindrical tubes integrally formed with end caps and being fastened together through a hook type fastening means.

13. The industrial filter assembly as claimed in claim 9, wherein the tubular molded body includes a cylindrical tube having end caps on both ends thereof, the end caps being fastened together through a hook or screw type fastening means.

14. The industrial filter assembly as claimed in claim 12, wherein the tubular molded body encases two or more membrane modules arranged in serial.

15. The industrial filter assembly as claimed in claim 9, wherein the tubular molded body has holes arranged to form a flow passage.

16. The industrial filter assembly as claimed in claim 9, wherein the tubular molded body comprises at least one transparent plastic material selected from the group consisting of a polypropylene resin, an acrylonitrile-butadiene-styrene copolymer resin, an acryl-based resin, a polymethacrylate resin, a polycarbonate resin and a cyclo-olefin copolymer/polymer resin.

17. The industrial filter assembly as claimed in claim 13, wherein the tubular molded body encases two or more membrane modules arranged in serial.
